(19) United States
(12) Patent Application Publication
(10) Pub. No.: US 2020/0366690 A1
(43) Pub. Date: Nov. 19, 2020

(54) ADAPTIVE NEURAL NETWORKS FOR NODE CLASSIFICATION IN DYNAMIC NETWORKS

(71) Applicant: NEC Laboratories America, Inc., Princeton, NJ (US)

(72) Inventors: Wei Cheng, Princeton Junction, NJ (US); Haifeng Chen, West Windsor, NJ (US); Wenchao Yu, Plainsboro, NJ (US); Dongkuan Xu, State College, PA (US)

(21) Appl. No.: 16/872,546

(22) Filed: May 12, 2020

Related U.S. Application Data
(60) Provisional application No. 62/848,876, filed on May 16, 2019.

(51) Int. Cl. H04L 29/06; G06N 3/08

(52) U.S. Cl. CPC H04L 63/1416; G06N 3/08

(57) ABSTRACT

Methods and systems for detecting anomalous behavior in a network include identifying topological state information in a dynamic network using a first neural network. Attribute state information in the dynamic network is identified, based on a partial labeling of nodes in the dynamic network, using a second neural network. The topological state information and the attribute state information are concatenated. Labels for unlabeled nodes in the dynamic network are predicted using a multi-factor attention, based on the concatenated state information. A security action is performed responsive to a determination that at least one node in the dynamic network is anomalous.

### RELATED APPLICATION INFORMATION

This application claims priority to 62/848,876 filed on May 16, 2019, incorporated herein by reference herein its entirety.

### BACKGROUND

### Technical Field

The present invention relates to network classification, and, more particularly, to the labeling remaining nodes in a network that has a partial set of labels.

### Description of the Related Art

The problem of classifying nodes in a network, where only a subset of the nodes are labeled at the outset, is challenging. Most existing approaches focus on static networks, and are unable to address networks that change over time. Additionally, it is difficult to learn the spatial and temporal information of the network's evolution at the same time. There are complex dynamics in the evolution of networks, as the temporal and spatial dimensions are entangled.

### SUMMARY

A method for detecting anomalous behavior in a network includes identifying topological state information in a dynamic network using a first neural network. Attribute state information in the dynamic network is identified, based on a partial labeling of nodes in the dynamic network, using a second neural network. The topological state information and the attribute state information are concatenated. Labels for unlabeled nodes in the dynamic network are predicted using a multi-factor attention, based on the concatenated state information. A security action is performed responsive to a determination that at least one node in the dynamic network is anomalous.

A system for detecting anomalous behavior in a network includes an adaptive neural network and a security console. The adaptive neural network includes a first neural network unit configured to identify topological state information in a dynamic network, a second neural network unit configured to identify attribute state information in the dynamic network, based on a partial labeling of nodes in the dynamic network, and an attention configured to concatenate the topological state information and the attribute state information and to predict labels for unlabeled nodes in the dynamic network using a multi-factor attention, based on the concatenated state information. The security console is configured to perform a security action responsive to a determination that at least one node in the dynamic network is anomalous.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a graph representation of a network of nodes, some of which are labeled, and some of which are unlabeled, in accordance with an embodiment of the present invention;

FIG. 2 is a block diagram of an adaptive neural network that is configured to provide labels for the unlabeled nodes of a partially labeled network, in accordance with an embodiment of the present invention;

FIG. 3 is a block/flow diagram of a method for identifying neighbors of a target node, in accordance with an embodiment of the present invention;

FIG. 4 is a block diagram of a multi-factor attention for an adaptive neural network in accordance with an embodiment of the present invention;

FIG. 5 is a block/flow diagram of a method for labeling the unlabeled nodes of a partially labeled network, in accordance with an embodiment of the present invention;

FIG. 6 is a block diagram of a system for labeling the unlabeled nodes of a partially labeled network, in accordance with an embodiment of the present invention;

FIG. 7 is a diagram of a neural network architecture, in accordance with an embodiment of the present invention; and

FIG. 8 is a diagram of a computer network that includes a number of normally operating systems and at least one anomalous system, in accordance with an embodiment of the present invention.

### DETAILED DESCRIPTION OF PREFERRED EMBODIMENTS

In accordance with embodiments of the present invention, node classification is performed for dynamic networks, with temporal and spatial information of the networks being learned simultaneously. An adaptive neural network may be used, for example, to track the links between nodes and the attributes of nodes in the network over time, with some of the labels being available at the outset for training. The remaining nodes' labels are predicted by the adaptive neural network.

Embodiments of the present invention can be used to, for example, identify abnormally operating systems in systems of physical objects. Interaction networks can be trained to reason about whether objects in a system are behaving anomalously or not. In particular, predictions and inferences can be made about various system properties in domains such as collision dynamics. These systems can be simulated using object- and relation-centric reasoning, using deep neural networks on graphs, with abnormal and normal behavior representing node classification attributes. When an anomaly is detected, the present embodiments can take an action, such as changing the status of the anomalous system's connections to other devices.

In other embodiments, nano-scale molecules can be interpreted as having a graph-like structure, with ions and atoms being the nodes, and with bonds between them being edges. The graph may evolve over time. The present embodiments can be employed to, for example, learn about existing molecular structures, and to predict the functional property of each node. For example, classification can be used to predict if each node in the graph is functional to some disease. As the topology of a biological structure changes over time, the changing pattern determines the functionality of given ions and atoms.

The present embodiments learn node representations for classification by considering the evolution of both network topology and node attributes. More specifically, at each step, an adaptive neural network learns node attribute information by aggregating the feature representation of a node and the representations of its local neighbors. To extract network topology information, the present embodiments can employ a random walk strategy to obtain the structural context of each node. The node attribute information and the structural context are further fed into two gated recurrent unit (GRU) networks to jointly learn the spatio-temporal information of node attributes and network topology.

In addition, a triple attention mechanism can be used to model three types of dynamics in network evolution. In particular, the attention mechanism on a spatial aspect helps to differentiate between the importance of different neighbors on the target node's representation. The attention mechanism on a temporal aspect helps to model the evolution of the importance at different time steps. A third attention mechanism helps to differentiate between the relative importance of node attributes and network topology in determining node representation.

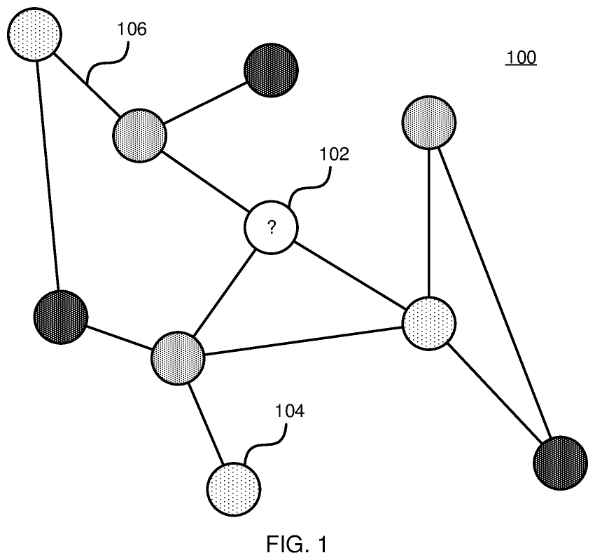

Referring now in detail to the figures in which like numerals represent the same or similar elements and initially to FIG. 1, an exemplary network graph 100 is illustratively depicted in accordance with one embodiment of the present invention. The graph 100 captures the topological structure of a dynamic network of objects, represented as nodes 104. As noted above, in some embodiments, such objects may represent physical objects in, e.g., a physical system. In some embodiments, the objects 104 may represent atoms or ions in a molecule. In yet other embodiments, the objects 104 may represent computing systems within a communications network. It should be understood that the illustrated graph is intended to be purely illustrative, and that the structure shown therein is not intended to be limiting in any way.

Edges 106 between the nodes 104 represent connections between the objects. For example, they may represent a chemical bond between two atoms, a structural connection between two physical objects, or a network communication between two computer systems. These connections develop and change over time, such that an edge 106 between two nodes 104 may disappear from one measurement to the next, while a new edge 106 may be formed between two different nodes 106 in the same interval.

Each node 104 in the network 100 includes one or more attributes or labels. These labels identify some characteristic of the node 104. For example, in a complex molecule, individual atoms and ions may be labeled as contributing to a pharmacological effect of the molecule, with some nodes 104 being labeled as contributing, and other nodes 104 being labeled as not contributing. In a computer network environment, the nodes 104 may be labeled according to roles within the network (e.g., server vs workstation), or according to conformance to expected behavior (e.g., normal vs anomalous). The labels may include, for example, an attribute vector, denoting multiple attributes of the node respective 104.

An initial set of edges 106 may be provided, for example in the form of a physical record, or may be inferred by pairwise regression of output data from pairs of objects 104. Edges 106 can be weighted or unweighted, directed or undirected. However, label and edge information may not be available for every node 104 and for every attribute of every node 104. Thus, some nodes 102 may be partially or entirely unlabeled at the outset.

The present embodiments identify the importance of different factors, such as neighboring nodes 104, attributes, and topology, that influence the labels of a node. Topology and attribute information is adaptively selected for integration over the evolution of the graph 100 through time.

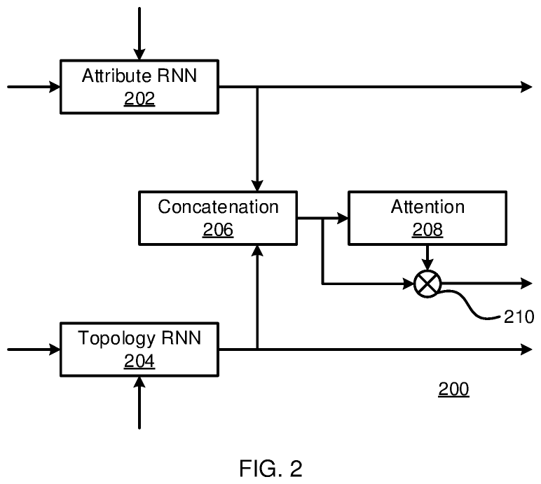

Referring now to FIG. 2, a high-level diagram of the structure of an adaptive neural network 200 is shown. Two GRUs are used, including attribute recurrent neural network (RNN) 202, which encodes the attributes of a particular node and its neighbors, and topology RNN 204, which encodes network topology dynamic evolution patterns. The two GRUs are used to consider the attribute information and the topology information jointly when generating a state vector. The outputs of the two GRUs are concatenated 206 to form a joint state vector at each time step. An attention module 208 processes the joint state vector, and its output is multiplied 210 with the joint state vector. A hidden representation uses the multiplied attention.

A dynamic network is represented as a collection of snapshots of the graph 100 at different time steps, denoted by G={G¹, G², . . . , G^{T}}, where T is the number of time steps. The graph 100 at a time step t is denoted as G^{t}=(V, A^{t}, X^{t}), with a fixed set of nodes V across the time steps. Each node 104 may have a consistent label across the time steps. A^{t} is an adjacency matrix in [symbol] ^{N×N} and X^{t} is a node attribute matrix in [symbol] ^{N×d}, where N is the number of vertices in V and d is the dimensionality of the attribute feature vector. Both A^{t} and X^{t} may be different at different time steps. Given G and the labels of a subset of nodes, V_{L}, the present embodiments classify the unlabeled nodes, V_{U}, where V=V_{L} ∪ V_{U}.

The topology RNN 204 takes as input a vector that includes topology information related to a target unlabeled node 102 and outputs a state vector. The topology RNN 204 may use random walk with restart (RWR) to extract a topology information vector of each node 104. Given a time step t, and a starting node v, the k-step RWR vector may be defined as p^{(k)}=cp^{(k-1)}[(D⁻¹)A^{t}]+(1−c)p⁽⁰⁾, where p^{(k)} ϵ [symbol] ₊^{1×N}. The element pᵤ^{(k)} indicates the probability of reaching a node u after k steps from an origin node v. The vector) p⁽⁰⁾ is an initial vector, with pᵥ⁽⁰⁾=1 and all other elements being equal to zero. D is a diagonal matrix, with elements corresponding to the sum of a row of A^{t}, dᵢᵢ=Σⱼ₌₁^{N}aᵢⱼ^{t}, with aᵢⱼ^{t} being an element of A^{t}. The term (1−c) is the probability that the random walker will restart from v. Therefore, the topology context vector for node v at the time step t is defined as:

$${a}^{t} = {\sum }_{k = 1}^{K} {p}^{( k )}$$

where K is the number of considered steps.

The topology RNN 204 is described by the equations below. A sequence of topology vectors of a node (e.g., a₁, . . . , a₁) are provided as input to the topology RNN 204. A state vector h*ₜ is calculated for each vector by applying the following equations iteratively:

z*ₜ=σ(W*_{z}[aₜ ⊕ h*ₜ₋₁]+b*_{z})

r*ₜ=σ(W*ᵣ[aₜ ⊕ h*ₜ₋₁]+b*ᵣ)

\tilde{h}*ₜ=tan h(W*ₕ[aₜ ⊕(r*ₜ ⊙ h*ₜ₋₁)]+b*ₕ)

h*ₜ=(1−z*ₜ)⊙ h*ₜ₋₁+z*ₜ ⊙ \tilde{h}*ₜ

where σ(·) is the sigmoid function, W*_{z}, W*ᵣ, W*ₕ ϵ [symbol] ^{d}^{ₕ}^{×(d+d}^{ₕ}⁾ and b*_{z}, b*ᵣ, b*ₕ ϵ [symbol] ^{d}^{ₕ} are parameters, dₕ is a hyper-parameter that denotes the size of state vector h*ₜ, the ⊕ operator is the concatenation operator, and ⊙ is the element-wise multiplication operator. The first state vector, h*₀, may be initialized to all zeroes, and the final state vector h*ₜ is the output.

The attribute RNN 202 captures attribute information from both a target node's attribute vector itself, and the representations of the target node's neighbors. The attribute RNN 202 considers neighboring information, besides the node attributes and the previous state vector, when generating new updates to the state vector. The operation of the attribute RNN is described by the equations below. Given a sequence of node attributes (e.g., x₁, . . . , x_{T}), and a sequence of neighborhood vectors (e.g., e₁, . . . , e_{T}), a state vector h′ₜ is calculated for each time step, by applying the following equations iteratively:

z′ₜ=σ(W′_{z}[xₜ ⊕ h′ₜ₋₁ ⊕ eₜ]+b′_{z})

r′ₜ=σ(W′ᵣ[xₜ ⊕ h′ₜ₋₁ ⊕ eₜ]+b′ᵣ)

s′ₜ=σ(W′ₛ[xₜ ⊕ h′ₜ₋₁ ⊕ eₜ]+b′ₛ)

\tilde{h}′ₜ=tan h(W′ₕ[xₜ ⊕(r′ₜ ⊙ h′ₜ₋₁)⊕(s′ₜ ⊙ eₜ)]+b′ₕ)

h′ₜ=(1−z′ₜ)⊙ h′ₜ₋₁+z′ₜ ⊙ \tilde{h}′ₜ

where b′_{z}, b′_{z}, b′_{z}, b′_{z} ϵ [symbol] ^{d}^{ₕ} and W′_{z}, W′ᵣ, W′ₛ ϵ [symbol] ^{d}^{ₕ}^{×(d+d}^{ₕ}^{+d}^{_{g}}⁾ are parameters and d_{g} is a hyper-parameter that denotes the size of the neighborhood representation. The terms z′ₜ, r′ₜ ϵ [symbol] ^{d}^{ₕ} and s′ₜ ϵ [symbol] ^{d}^{_{g}} are the update, reset, and neighborhood gates, respectively. The gates control information when generating the state vector. In particular, \tilde{h}′ₜ represents a new proposal. The values in the gates are in the range from zero to one. The term r′ₜ ⊙ h′ₜ₋₁ indicates how much information to keep from the previous state vector, and s′ₜ ⊙ eₜ indicates how much information to keep from the neighborhoods.

A neighborhood vector is extracted for each node, at each time step, to represent the neighborhood information of the target node 102, with the goal of aggregating the neighbors' representations. Neighbors within K hops are considered.

Training of the adaptive neural network 200 is transductive. A sequence of attribute graphs over T time steps are used, denoting the evolution of the graph over time. Both topology and node attributes evolve over time. Throughout the entire time period, each node will have only one label, with some being known from the beginning, and with others being unknown. Training uses the sequence of attributed graphs, together with the known labels, to train the model. After training, the model predicts the labels of the unlabeled nodes.

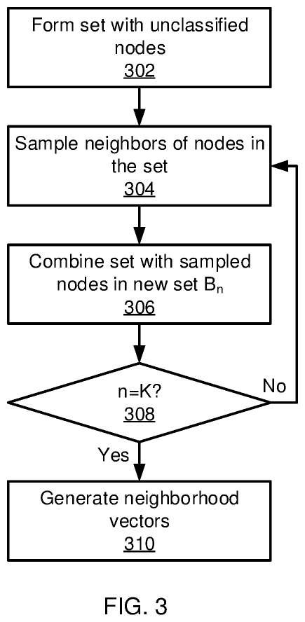

Referring now to FIG. 3, a method for preparing the K-hop neighbors of a target node 102 is shown. Block 302 forms a set B₀ of unclassified nodes 102 in a graph 100. Block 304 then identifies the neighbors of each of the nodes in the set, based on the edges 106 in the graph 100. The neighbors can be sampled in block 304 using a sampling function [symbol] (·). In some embodiments, the sampling function may be a simply random sampling. Block 306 creates a new set, B₁, that combines B₀ with the newly identified nodes. This represents a first iteration.

Block 308 determines whether the number of iterations, n, is equal to the maximum number of hops, K. If not, another iteration begins, with block 304 identifying the neighbors of the nodes in the previously generated set Bₙ₋₁, and with block 306 creating a new set, Bₙ, that combines Bₙ₋₁ with the newly identified nodes. The result is a series of sets, B₀, . . . , B_{K}. Once the condition n=K is reached at block 308, block 310 generates neighborhood vectors for all of the nodes in B.

A representation, gₜ₍ᵥ₎^{k}, is formed for the node v after aggregating its k^{th} hop neighbors at time step t, with gₜ₍ᵥ₎^{K}←xₜ₍ᵥ₎, ∀v ϵ Bₜ^{K}. For each set B_{K-1}, . . . , B₀, the representation is iteratively determined. Aggregating neighbors' representations can be performed gₜ₍ᵥ₎^{k+1}←AGGₖ₊₁({gₜ₍ᵤ₎^{k+1}, ∀u ϵ [symbol] (v)}), where AGG(·) is an aggregator function described in greater detail below. A new representation can then be generated as gₜ₍ᵥ₎^{k}←σ(Wₜᵣₐₙₛ^{k+1}[gₜ₍ᵥ₎^{k+1} ⊕ [symbol] ]), where Wₜᵣₐₙₛ^{k+1} ϵ [symbol] ^{d}^{_{g}}^{×2d}^{_{g}} is a transformation matrix to be learned. For each vertex v in the set of unassigned nodes at time t, Bₜ⁰, the neighborhood vector can then be determined as eₜ₍ᵥ₎←AGG₁({gₜ₍ᵤ₎¹, ∀u ϵ [symbol] (v)}).

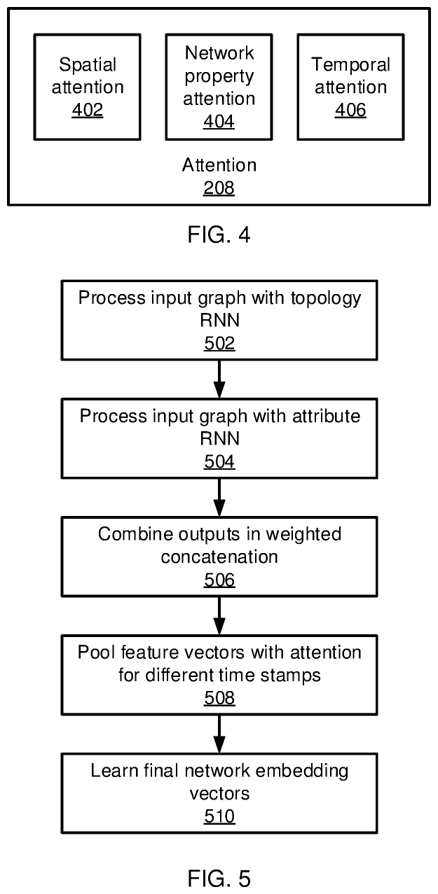

Referring now to FIG. 4, additional detail on the attention model 208 is shown. The attention model 208 includes three types of dynamics to capture network evolution, including spatial dynamics 402, temporal dynamics 406, and network property dynamics 404.

For spatial attention 402, different neighbors influence node presentations in diverse ways. Attention can adaptively capture the relevant spatial information. Spatial attention 402 is applied to the aggregator AGG(·) during the aggregation process for forming neighborhood vectors, in block 310. Based on the attention values, the aggregator combines neighbors' representations as follows:

$$A G {G}_{k} ( \{ {g}_{t ( u )}^{k} , ∀ u ∈ 𝒩 ( v ) \} ) = {\sum }_{u ∈ 𝒩 ( v )} {β}_{u}^{k} {V}_{k} {g}_{t ( u )}^{k}$$

where βᵤ^{k} is the attention value of neighbor u at hop k, Σβᵤ^{k}=1, and Vₖ ϵ [symbol] ^{d}^{_{g}}^{×d}^{_{g}} are parameters. The attention value βᵤ^{k} indicates the importance of u to the node v, as compared to other neighbors located at the k^{th} hop. βᵤ^{k} is produced based on representations of the node and its neighbors, as follows:

$${β}_{u}^{k} = \frac{exp \{ F ( {w}_{k}^{T} [ {V}_{k} {g}_{t ( u )}^{k} ⊕ {V}_{k} {g}_{t ( v )}^{k} ] ) \}}{{Σ}_{{v}^{′} ∈ 𝒩 ( v )} exp \{ F ( {w}_{k}^{T} [ {V}_{k} {g}_{t ( {v}^{′} )}^{k} ⊕ {V}_{k} {g}_{t ( v )}^{k} ] ) \}}$$

where F(·) is an activation function and wₖ ϵ [symbol] ^{d}^{_{g}} are parameters. Thus, βᵤ^{k} is takes the representations of the node and its neighbors as inputs, and calculates the attention weights of different neighbor nodes for a given node u.

Network properties vary for different networks. The node attributes and network topology will have different degrees of influence on node labels in different networks. Even within a given network, the relative importance of attributes and topology can change over time. The network property attention 404 therefore automatically assigns levels of attention to attributes and topology as the network evolves.

The network property attention 404 takes the state vectors h′ₜ and h*′ₜ as inputs and generates attention values γ′ₜ and γ*ₜ as follows:

$${γ}_{t}^{*} = \frac{exp \{ {\ddot{w}}^{T} tanh ( \ddot{V} {h}_{t}^{*} ) \}}{exp \{ {\ddot{w}}^{T} tanh ( \ddot{V} {h}_{t}^{*} ) + exp \{ {\ddot{w}}^{T} tanh ( \ddot{V} {h}_{t}^{′} )}$$

$${γ}_{t}^{′} = \frac{exp \{ {\ddot{w}}^{T} tanh ( \ddot{V} {h}_{t}^{′} ) \}}{exp \{ {\ddot{w}}^{T} tanh ( \ddot{V} {h}_{t}^{*} ) + exp \{ {\ddot{w}}^{T} tanh ( \ddot{V} {h}_{t}^{′} )}$$

where \ddot{w}^{T} ϵ [symbol] ^{d}^{_{γ}} and \ddot{V} ϵ [symbol] ^{d}^{_{γ}}^{×d}^{ₕ} are parameters. The attention values γ′ₜ and γ*ₜ represent the relative importance of network attributes and network topology, respectively, at time step t for determining the target node's label. The two state vectors can be concatenated 206, scaled by their attention values, as follows:

hₜ=[(γ*ₜ×h*ₜ)^{T} ⊕ (γ′ₜ×h′ₜ)^{T}]^{T} ϵ [symbol] ^{2d}^{ₕ}

where d_{γ} is a hyper-parameter that denotes the subspace size for calculating the attention weights for attributes and topology hidden representations, used for the aggregation of these two parts.

Temporal attention 406 pats different levels of attention to different time steps, as the amount of useful information in different snapshots of the network, taken at different times, can differ. Only some time steps include the most discriminative information for determining node labels.

Temporal attention 406 takes the concatenated vector hₜ as input and outputs an attention value for it as follows:

$${α}_{t} = \frac{exp \{ {\tilde{w}}^{T} tanh ( \tilde{V} {h}_{t} ) \}}{{Σ}_{i = 1}^{T} exp \{ {\tilde{w}}^{T} tanh ( \tilde{V} {h}_{i} ) \}}$$

where \tilde{w} ϵ [symbol] ^{d}^{_{α}} and \tilde{V} ϵ [symbol] ^{d}^{_{α}}^{×2d}^{ₕ} are parameters, and d_{α} is a hyper-parameter that represents a number of subspace to project hₜ into to get the attention weights of importance for each hₜ for aggregation. The attention αₜ indicates the importance of time step t for determining a target node's label.

The vectors hₜ are concatenated as:

H=[h₁ ⊕ . . . ⊕ h_{T}]ϵ [symbol] ^{T×2d}^{ₕ}

The attention values of different time steps are therefore expressed as:

α=softmax(\tilde{w}^{T} tan h(V̅H^{T}))ϵ [symbol] ^{T}

The state vectors are then summed, scaled by α, to generate a vector representation q for the node as follows:

q=α^{T}H ϵ [symbol] ^{2d}^{ₕ}

The output of an attention unit generally focuses on one part of the temporal pattern of a node. However, it is possible that multiple parts, together, describe the overall pattern. If there are m parts needed from the input, then m different parameters \tilde{w}ₘ and concatenate them as \tilde{W}=[\tilde{w}₁ ⊕ . . . ⊕ \tilde{w}ₘ]. The resulting attention value matrix is:

A=softmax(\tilde{W}^{T} tan h(\tilde{V}H^{T}))ϵ [symbol] ^{m×T}

where softmax(·) performs on the second dimension of its input. The final representation is then denoted by:

Q=AH ϵ [symbol] ^{m×2d}^{ₕ}

Given node representations, denoted by Q₁, . . . , Q_{N}, and the node labels y₁, . . . , y_{N}, where N is the number of nodes, the objective function of the adaptive neural network is:

J=L_{ce}+λ₁Pₐₜₜ+λ₂Pₙₙ

where

$${L}_{c e} = - \frac{1}{N} {Σ}_{i = 1}^{N} {y}_{i} log ( {\tilde{y}}_{i} )$$

is the cross-entropy loss, and \tilde{y}ᵢ is the estimate produced by applying softmax(·) to the output of a fully connected layer that takes the node representation as its input. Thus, \tilde{y}ᵢ=softmax(WₒQᵢ+bₒ), where Wₒ ϵ [symbol] ^{c×md}^{ₕ} and bₒ ϵ [symbol] ^{c} are parameters, c is the number of classes, Pₐₜₜ=∥AA^{T}−I∥_{F}² is a penalization term to encourage multiple temporal attentions to diverge from each other, Pₙₙ is a penalization term for the parameters to prevent the adaptive neural network from overfitting, and λ₁ and λ₂ are hyper-parameters. By optimizing (e g , minimizing) this objective function, the node labels can be determined.

Referring now to FIG. 5, a method of predicting the labels of nodes in a network, based on a partial set of labels, is shown. Block 502 processes an input graph, including information relating to the evolution of the graph over time, with a topology RNN 204. Block 502 generates a set of topology state vectors that represent this structural information. Block 504 processes the input graph, including information relating to the evolution of node labels over time and a partial set of label vectors, with an attribute RNN 202. Block 504 generates a set of attribute state vectors.

Block 506 combines the topology state vectors and the attribute state vectors by a weighted concatenation. Block 508 then uses spatial attention 402, network property attention 404, and temporal attention 406 to determine an attention value matrix that captures three different kinds of information in the evolution of the network. Using the attention value matrix, block 510 learns final network embedding vectors and node labels by minimizing an objective function for the adaptive neural network. These node labels include labels for the previously unlabeled network nodes.

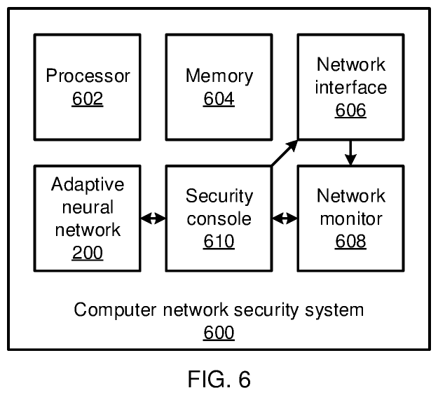

Referring now to FIG. 6, a computer network security system 600 is shown. It should be understood that this system 600 represents just one application of the present principles, and that other uses for predicting the labels of nodes in a dynamic network are also contemplated. The system 600 includes a hardware processor 602 and a memory 604. A network interface 606 communicates with one or more other systems on a computer network by, e.g., any appropriate wired or wireless communication medium and protocol.

The adaptive neural network 200 can be implemented as described above, with one or more discrete neural network configurations being implemented to provide predictions for unlabeled nodes in the network. In some embodiments, the nodes may represent computer systems on a computer network, with some of the identities and functions of the computer systems being known in advance, while other systems may be unknown. The adaptive neural network 200 identifies labels for these unknown systems.

Network monitor 608 thus receives information from the network interface 606 regarding the state of the network. This information may include, for example, network log information that tracks physically connections between systems, as well as communications between systems. The network log information can be received in an ongoing manner from the network interface and can be processed by the network monitor to identify changes in network topology (both physical and logical) and to collect information relating to the behavior of the systems.

In some embodiments, the adaptive neural network 200 can identify systems in the network that are operating normally, and also systems that are operating anomalously. For example, a system that is infected with malware, or that is being used as an intrusion point, may operate in a manner that is anomalous. This change can be detected as the network evolves, making it possible to identify and respond to security threats within the network.

A security console 610 manages this process. The security console 610 reviews information provided by the adaptive neural network 200, for example by identifying anomalous systems in the network, and triggers a security action in response. For example, the security console 610 may automatically trigger security management actions such as, e.g., shutting down devices, stopping or restricting certain types of network communication, raising alerts to system administrators, changing a security policy level, and so forth. The security console 610 may also accept instructions from a human operator to manually trigger certain security actions in view of analysis of the anomalous host. The security console 610 can therefore issue commands to the other computer systems on the network using the network interface 606.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

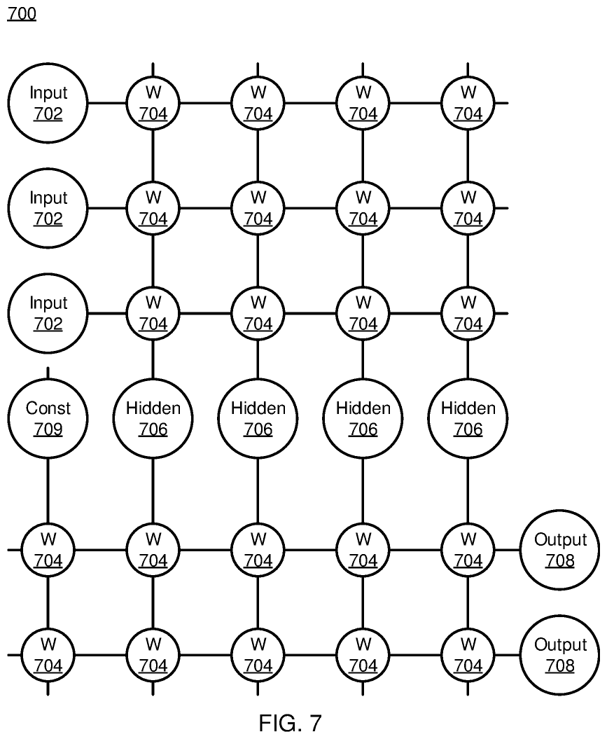

Referring now to FIG. 7, an artificial neural network (ANN) architecture 700 is shown. It should be understood that the present architecture is purely exemplary and that other architectures or types of neural network may be used instead. The ANN embodiment described herein is included with the intent of illustrating general principles of neural network computation at a high level of generality and should not be construed as limiting in any way.

Furthermore, the layers of neurons described below and the weights connecting them are described in a general manner and can be replaced by any type of neural network layers with any appropriate degree or type of interconnectivity. For example, layers can include convolutional layers, pooling layers, fully connected layers, softmax layers, or any other appropriate type of neural network layer. Furthermore, layers can be added or removed as needed and the weights can be omitted for more complicated forms of interconnection.

During feed-forward operation, a set of input neurons 702 each provide an input signal in parallel to a respective row of weights 704. The weights 704 each have a respective settable value, such that a weight output passes from the weight 704 to a respective hidden neuron 706 to represent the weighted input to the hidden neuron 706. In software embodiments, the weights 704 may simply be represented as coefficient values that are multiplied against the relevant signals. The signals from each weight adds column-wise and flows to a hidden neuron 706.

The hidden neurons 706 use the signals from the array of weights 704 to perform some calculation. The hidden neurons 706 then output a signal of their own to another array of weights 704. This array performs in the same way, with a column of weights 704 receiving a signal from their respective hidden neuron 706 to produce a weighted signal output that adds row-wise and is provided to the output neuron 708.

It should be understood that any number of these stages may be implemented, by interposing additional layers of arrays and hidden neurons 706. It should also be noted that some neurons may be constant neurons 709, which provide a constant output to the array. The constant neurons 709 can be present among the input neurons 702 and/or hidden neurons 706 and are only used during feed-forward operation.

During back propagation, the output neurons 708 provide a signal back across the array of weights 704. The output layer compares the generated network response to training data and computes an error. The error signal can be made proportional to the error value. In this example, a row of weights 704 receives a signal from a respective output neuron 708 in parallel and produces an output which adds column-wise to provide an input to hidden neurons 706. The hidden neurons 706 combine the weighted feedback signal with a derivative of its feed-forward calculation and stores an error value before outputting a feedback signal to its respective column of weights 704. This back propagation travels through the entire network 700 until all hidden neurons 706 and the input neurons 702 have stored an error value.

During weight updates, the stored error values are used to update the settable values of the weights 704. In this manner the weights 704 can be trained to adapt the neural network 700 to errors in its processing. It should be noted that the three modes of operation, feed forward, back propagation, and weight update, do not overlap with one another.

In some embodiments, the adaptive neural network 200 may include RNNs 202 and 204, as well as a fully connected layer, a tan h layer, a second fully connected layer, and a softmax layer in the attention network 208.

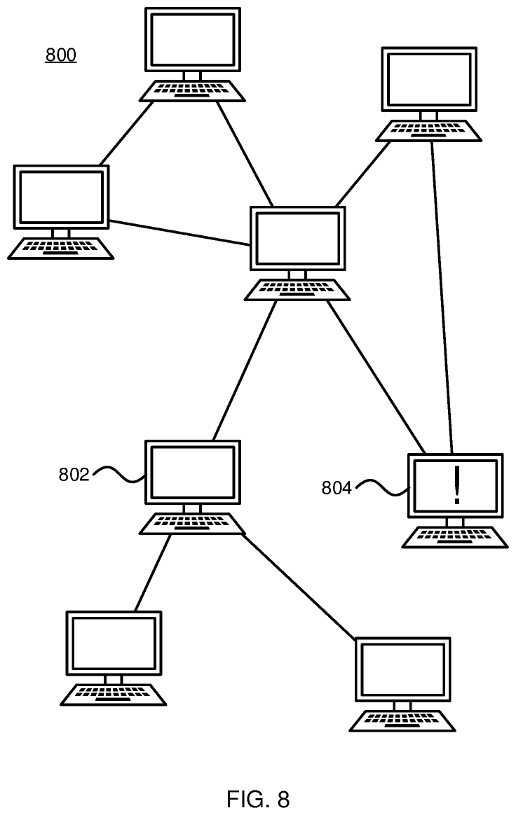

Referring now to FIG. 8, an embodiment is shown that includes a network 800 of different computer systems 802. The functioning of these computer systems 802 can correspond to the labels of nodes in a network graph that identifies the topology and the attributes of the computer systems 802 in the network. At least one anomalous computer system 804 can be identified using these labels, for example using the labels to identify normal operation and anomalous operation. In such an environment, the computer network security system 600 can identify and quickly address the anomalous behavior, stopping an intrusion event or correcting abnormal behavior, before such activity can spread to other computer systems.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for detecting anomalous behavior in a network, comprising:
identifying topological state information in a dynamic network using a first neural network;
identifying attribute state information in the dynamic network, based on a partial labeling of nodes in the dynamic network, using a second neural network;
concatenating the topological state information and the attribute state information;
predicting labels for unlabeled nodes in the dynamic network using a multi-factor attention, based on the concatenated state information; and
performing a security action responsive to a determination that at least one node in the dynamic network is anomalous.

2. The method of claim 1, wherein the first neural network and the second neural network are separately trained.

3. The method of claim 1, wherein the multi-factor attention includes spatial attention, temporal attention, and network property attention.

4. The method of claim 3, wherein spatial attention identifies an influence of neighbors on representations of neighboring nodes.

5. The method of claim 3, wherein temporal attention identifies an influence of different time steps in an evolution of the dynamic network.

6. The method of claim 3, wherein network property attention identifies degrees of contribution between a topology and attributes of the dynamic network.

7. The method of claim 1, wherein predicting the labels includes optimizing the objective function:
J=L_{ce}+λ₁Pₐₜₜ+λ₂Pₙₙ
where L_{ce} is a cross-entropy loss that includes the labels, Pₐₜₜ is a penalization term to encourage multiple temporal attentions to diverge from each other, Pₙₙ is a penalization term for the parameters to prevent the adaptive neural network from overfitting, and λ₁ λ₂ are hyper-parameters.

8. The method of claim 7, wherein the cross-entropy loss is expressed as:
$${L}_{c e} = - \frac{1}{N} {\sum }_{i = 1}^{N} {y}_{i} log ( {\tilde{y}}_{i} )$$
where N is a number of unlabeled nodes, yᵢ is a node label, and \tilde{y}ᵢ is an estimate produced by applying softmax(·) to an output of a fully connected layer that takes node representation as its input.

9. The method of claim 1, wherein the first neural network and the second neural network are both gated recurrent unit networks.

10. The method of claim 1, wherein the security action is selected from the group consisting of shutting down devices, stopping or restricting a type of network communication, enabling or disabling a connection between two devices, raising an alert to a system administrator, and changing a security policy level.

11. A system for detecting anomalous behavior in a network, comprising:
an adaptive neural network, comprising:
a first neural network unit configured to identify topological state information in a dynamic network;
a second neural network unit configured to identify attribute state information in the dynamic network, based on a partial labeling of nodes in the dynamic network; and
an attention configured to concatenate the topological state information and the attribute state information and to predict labels for unlabeled nodes in the dynamic network using a multi-factor attention, based on the concatenated state information; and
a security console configured to perform a security action responsive to a determination that at least one node in the dynamic network is anomalous.

12. The system of claim 11, wherein the first neural network and the second neural network are separately trained.

13. The system of claim 11, wherein the multi-factor attention includes spatial attention, temporal attention, and network property attention.

14. The system of claim 13, wherein spatial attention identifies an influence of neighbors on representations of neighboring nodes.

15. The system of claim 13, wherein temporal attention identifies an influence of different time steps in an evolution of the dynamic network.

16. The system of claim 13, wherein network property attention identifies degrees of contribution between a topology and attributes of the dynamic network.

17. The system of claim 11, wherein the attention is configured to predict the labels by optimizing the objective function:
J=L_{ce}+λ₁Pₐₜₜ+λ₂Pₙₙ
where L_{ce} is a cross-entropy loss that includes the labels, Pₐₜₜ is a penalization term to encourage multiple temporal attentions to diverge from each other, Pₙₙ is a penalization term for the parameters to prevent the adaptive neural network from overfitting, and λ₁ λ₂ are hyper-parameters.

18. The system of claim 17, wherein the cross-entropy loss is expressed as:
$${L}_{c e} = - \frac{1}{N} {\sum }_{i = 1}^{N} {y}_{i} log ( {\tilde{y}}_{i} )$$
where N is a number of unlabeled nodes, yᵢ is a node label, and y̅ᵢ is an estimate produced by applying softmax(·) to an output of a fully connected layer that takes node representation as its input.

19. The system of claim 11, wherein the first neural network unit and the second neural network unit are both gated recurrent unit networks.

20. The system of claim 11, wherein the security action is selected from the group consisting of shutting down devices, stopping or restricting a type of network communication, enabling or disabling a connection between two devices, raising an alert to a system administrator, and changing a security policy level.
